(19) United States
(12) Patent Application Publication
(10) Pub. No.: US 2016/0330722 A1
(43) Pub. Date: Nov. 10, 2016

(54) APPARATUS AND METHOD FOR PROVIDING A UNIFYING IDENTIFIER ON WIRELESS NETWORKS

(71) Applicant: Spreadtrum Hong Kong Limited, Shanghai (CN)

(72) Inventors: Anna PANTELIDOU, Oulu (FI); Hannu HIETALAHTI, Kiviniemi (FI)

(21) Appl. No.: 14/708,157

(22) Filed: May 8, 2015

(51) Int. Cl. H04W 72/04; H04W 28/02; H04W 8/20

(52) U.S. Cl. CPC H04W 72/0406; H04W 8/20; H04W 28/02; H04W 84/02

(57) ABSTRACT

A method and system for providing a unifying identifier for a user device across different wireless networks. The different wireless networks include a first wireless network and a second wireless network. The second wireless network receives information from the first wireless network, associates a unifying identifier for the user device based on the received information, and assigns the unifying identifier to the user device. The information from the first wireless network indicates a priority or a quality or level of service provided to the user device by the first wireless network.

### BACKGROUND

1. Technical Field

The present disclosure relates to interworking between communications networks and in particular relates to apparatuses and methods for identifying a user in a unified way across networks.

2. Background

Wireless networks face technical challenges. The fast increasing number of wireless devices requires an increasing number of connections and, with network capacity growing at a slower pace, causes more congestion each day. For example, networks operating on cellular standards (e.g., 3GPP) are in constant demand of capacity by the end users. For cost-efficient service offering, the operators are considering alternative access technologies, at least locally. In general cases, such alternative access technology could be any non-3GPP technology. The principle disclosed here is technology agnostic. At the moment, WLAN (wireless local area network) on license-free spectrum has been widely deployed; the number of WLAN enabled devices is constantly increasing; and current IEEE 802,11 ac standard promises rates exceeding 1 Gbps. Network operators thus find WLAN a possible route to offload IP (Internet Protocol) traffic in case of network congestion. Hence in this disclosure, we describe the principle of the method in WLAN terminology. But the principles disclosed here are not limited to any particular technology.

The topic of 3GPP-WLAN interworking has been under discussion in 3GPP over several releases (see e.g., 3GPP TS 23.234, 3GPP TR 23.861, 3GPP TS 23.402, 3GPP TS 24.302, 3GPP TS 24.312).

In 3GPP-WLAN interworking schemes, when a UE (User Equipment) is under both 3GPP and WLAN coverage, and either some part or all of the UE's IP traffic may be offloaded from one network to the other when certain conditions are met. For example, when the UE is serviced by a 3GPP network and a WLAN network is available, the network may offload IP traffic from 3GPP network to WLAN network. Then, when the UE moves out of the WLAN network coverage, the WLAN network should be able to transfer the UE back to the 3GPP network. In another example, when the UE is serviced by a 3GPP network and a WLAN network is available, and the network decides to offload IP traffic from 3GPP network to WLAN network, the network may direct the UE to perform handoff procedure to completely switch from 3GPP network to WLAN network.

The different networks provide different types of identifiers for the difference pieces of user equipment or users. A 3GPP UE can be identified by several identifiers, including its TMSI (Temporary Mobile Subscriber Identity), IMSI (International Mobile Subscriber Identity), IMEI (International Mobile Equipment Identity), P-TMSI (Packet Temporary Mobile Subscriber Identity). When a device switches from a non-3GPP network to a 3GPP network, it is assigned an NAI (Network Access Identifier) (3GPP TS 23.003), for example, a “Root NAI.” An NAI has the form of username@realm (clause 2.1 of IETF RFC 4282) where the username is obtained from the IMSI. According to 3GPP TS 23.003, clause 14, the Root NAI is built as follows:
1) an identity confirming to the NAI format is generated from IMSI as defined in EAP (Extensible Authentication Protocol) SIM (Subscriber Identity Module) and EAP AKA (Authentication and Key Agreement) as appropriate; and
2) leading digits of the IMSI, i.e., MNC (Mobile Network Code) and MCC (Mobile Country Code), are converted into a domain name, as described in sub-clause 14.2 of 3GPP TS 23.003.

The result will be a root NAI of the form:
“0<IMSI>@wlan.mnc<MNC>.mcc<MCC>.3gppnetwork.org”, for EAP AKA authentication; and
“1<IMSI>@wlan.mnc<MNC>.mcc<MCC>.3gppnetwork.org”, for EAP SIM authentication,

As described in 3GPP TS 24.302, when a user subsequently reaches EPC (Evolved Packet Core) via a non-3GPP access network, the user identifies itself with either a root NAI or a decorated NAI as described to receive authentication, authorization, and accounting services.

Access to non-3GPP networks operates on an additional, independent, identifier that is out of the scope of 3GPP (see 3GPP TS 24.302). For example, in WLAN, during an association process, the WLAN AP assigns to an STA an AID (Association IDentitier). The AID is a 16-bit identifier for the STA or user. The AID takes values in 1-2007 (see section 8.4,1.8 in IEEE 802.11-2012). The AID values are placed in the 14 LSBs (Least Significant Bits) of an AID field. The 2 MSBs (Most Significant Bits) of the AID field are set to 1 (see section 8.2,4.2 in IEEE 802.11-2012). The AID is provided in an Association Response message from the WLAN AP to the STA (see section 8,3,3.6, Table 8-23 in IEEE 802.11-2012), independently of the user's subscription information, rate, device type, etc. on the 3GPP network.

Problems exist under currently proposed interworking schemes. As an example, in cellular networks, users can have different subscription levels/plans, typically associated with different fee payments, depending on their agreements with the network operator. In contrast, each user on a WLAN network has equal probability of accessing a channel through its selection of back-off time and contention window. Certainly, in WLAN some users may be located in more advantageous locations (e.g., users located closer to a WLAN AP (Access Point) than others (e.g., users located farther away from the WLAN AP, users of exposed terminals that must defer transmissions upon sensing transmissions of neighboring nodes which do not in fact constitute interference, or users that lie inside an OBSS (Overlapping Basic Service Set) area). Thus, in practice WLAN users do not have different plans or subscription levels since they all have the same probability of gaining channel access. Users with different service plans or subscription levels on a cellular network do not receive the corresponding levels of service on the WLAN networks,

Additionally, networks may further support different types of devices with different requirements in terms of data transmission, sleeping opportunities, energy efficiency, etc. Existing WLAN protocols do not provide methods to take network heterogeneity into account,

It may be beneficial for the different networks to accord similar priority or level of service to a particular user or piece of UE. This is not possible when the networks use different types of identifiers and a network (such as WLAN networks) does not differentiate users based on service plans or subscription levels. For example, an identifier for a 3GPP user correlates to a given QoS (Quality of Service) or a subscription plan on a 3GPP network, or associates a UE to a particular device type. Such correlation does not propagate through an AID assigned by a WLAN AP when the user or UE is offloaded onto the WLAN.

### SUMMARY

Consistent with embodiments of this disclosure, there is provided a method of providing a unifying identifier for a user device across different wireless networks including a first wireless network and a second wireless network. The method includes receiving, at the second wireless network, information from the first wireless network; associating a unifying identifier for the user device based on the received information; and assigning the unifying identifier to the user device. The information from the first wireless network indicates a priority or a quality or level of service provided to the user device by the first wireless network.

Consistent with embodiments of this disclosure, there is also provided a method of a user device communicating with a first wireless network and a second wireless network. The method includes, while in communication with the first wireless network, receiving a unifying identifier from the second wireless network, and communicating with the second wireless network using the unifying identifier. The unifying identifier reflects a priority or a quality or level of service provided to the user device by the first wireless network.

Consistent with embodiments of this disclosure, there is further provided a method of a first wireless network for offloading at least part of a user device's traffic to a second wireless network. The method includes transmitting information to the second wireless network; indicating to the user device to offload traffic to the second wireless network; and receiving from the second wireless network a unifying identifier for the user device. The information indicates a priority or a quality or level of service provided to the user device by the first wireless network and the unifying identifier is associated with the priority or quality or level of service.

Consistent with embodiments of this disclosure, there is further provided a device for communicating with a first wireless network and a second wireless network. The device includes a processor and a computer readable storage medium storing programming for execution by the processor. The processor is configured for the device to, while in communication with the first wireless network, receive a unifying identifier from the second wireless network; and communicate with the second wireless network with using the unifying identifier. The unifying identifier reflects a priority or a quality or level of service provided to the user device by the first wireless network.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 shows an exemplary architecture of a system for illustration of 3GPP to WLAN offloading or WLAN to 3GPP offloading consistent with the present disclosure;

FIG. 2 illustrates an exemplary architecture of a system providing a unifying identifier in 3GPP and WLAN networks;

FIG. 3 illustrates an exemplary method for providing a unifying identifier across wireless networks;

FIG. 4 illustrates an exemplary embodiment of splitting AID space;

FIG. 5 illustrates an exemplary allocations of AID ranges;

FIG. 6 illustrates an exemplary method for providing a unifying identifier across wireless networks;

FIG. 7 illustrates an example of AIDS corresponding to user category groups;

FIG. 8 illustrates an exemplary method for providing a unifying identifier across wireless networks;

FIG. 9 illustrates an exemplary network-centric method for providing a unifying identifier across wireless networks;

FIG. 10 illustrates an exemplary UE-centric method for providing a unifying identifier across wireless networks; and

FIG. 11 illustrates an exemplary block diagram of a network apparatus or a user equipment apparatus.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Consistent with disclosure herein, there are provided apparatuses, systems, and methods for providing unifying identifiers across different networks to allow interworking. The different networks may comprise cellular network and non-cellular networks (36PP vs. WLAN), or cellular networks with different infrastructures (e.g., 3GPP vs. 3GPP2), or different cellular networks with different access technologies (e.g., 20G vs, 3G vs, 4G/LTE), or any two or more networks that do not already operate on unifying identifiers for users or pieces of user equipment. In this disclosure, the terms user equipment (UE), device, and station (STA), are used interchangeably.

A unifying identifier may identify a user equipment or a device or a user on a second wireless network in such a way as to associate with the user's subscription plan on a first wireless network or other parameters that suggest quality of services (QoS) or level of services the user receives on the first wireless network and should therefore receive on the second wireless network. The unifying identifier may be the same or different between the first and second wireless networks. Also, as discussed further below, the unifying identifier may identify individual user devices or a category or set of user devices. Treating a user or user equipment or a device in a unified way may facilitate better interworking and a better QoS experience across different networks. For instance, when offloading IP traffic from 3GPP networks to WLAN networks, it would be reasonable to expect that users that experience the longest delays on the WLAN networks are those with the most basic subscription plans on the cellular networks (e.g., 2G), and other users who experience the shortest delays on the WLAN networks are those with the most expensive subscriptions on the cellular networks (e.g., 4G/LTE).

Additionally, a unifying identifier may also allow customization or optimization of device operation across networks. If a device type, known on a cellular network, is made known on a WLAN network through a unifying identifier, access parameters may be used to optimize device operation. For instance, a high resolution surveillance camera may need infrequent access to a large amount of channel resources (e.g., a long TXOP) on a WLAN network to transmit all data and long sleeping opportunities as its transmission may be infrequent.

The disclosed methods, schemes, devices, and systems work in an environment where all traffic is switched between two radio access technologies, as well as where different data flows can be selectively routed via different access technologies based on the QoS needs and priority.

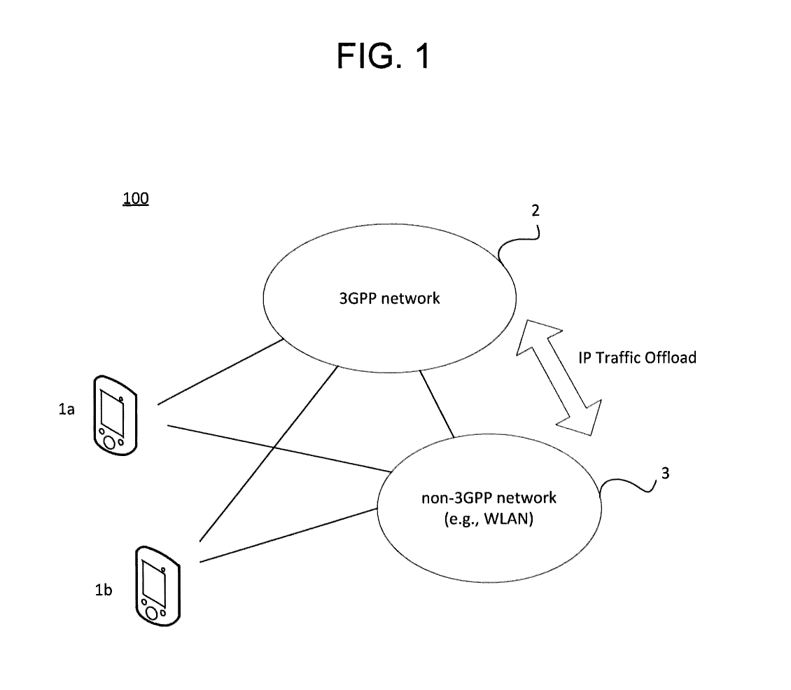

FIG. 1 illustrates an exemplary architecture of a system consistent with this disclosure. FIG. 1 illustrates the possibilities of offloading IP traffic between different networks. The system 100 comprises for example, a plurality of UEs 1a, 1b, a 3GPP network 2, and a non-3GPP network 3. The 3GPP network 2 may provide accesses under the 2G, 3G, 4G/LTE standards or other subsequent 3GPP standards or extensions of the existing ones. The non-3GPP network 3 may comprise WLAN, WiMAX, cdma2000, etc. 3GPP network 2 and non-3GPP network 3 may have separate subscription plans.

FIG. 1 illustrates a case scenario of offloading IP traffic from a 3GPP network 2 to, for example, a WLAN network. Although not illustrated in the figure, offloading from a WLAN network to 3GPP network 2 is possible too. Consistent with embodiments of this disclosure, a device receives a unifying identifier that is recognized by both the 3GPP network 2 and WLAN network.

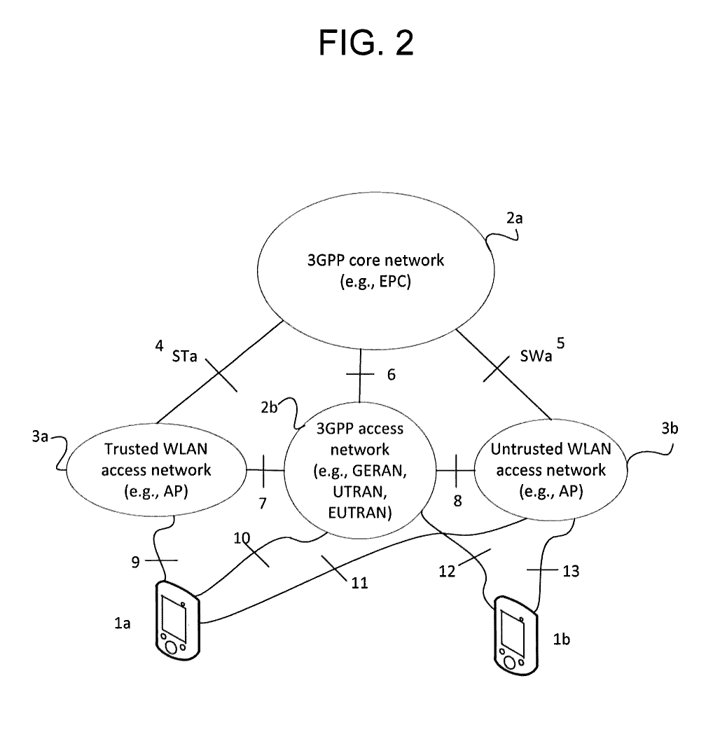

FIG. 2 provides more details of the system 100 of FIG. 1. 3GPP network 2 comprises a 3GPP core network 2a, or a 3GPP access network 2b, or both. 3GPP access network 2b may support one or more access technologies such as GERAN (GSM EDGE Radio Access Network), UTRAN (UMTS Radio Access Network), EUTRAN (Evolved UMTS Radio Access Network), etc. WLAN access network 3a or 3b may comprise a trusted WLAN access network 3a or an untrusted WLAN access network 3b or both.

3GPP network 2 may provide a plurality of functions including, but not limited to, for example, storing user-related and subscriber-related information, authorizing and authenticating a user/UE, supporting mobility management and session management, allocating IP address or controlling policies, charging, routing incoming and outgoing IP packets, etc. Such information as user-related and subscriber-related information, priority information, user categories information, device type information, etc. can be transferred from either 3GPP core network 2a or 3GPP access network 2b to WLAN AP 3a or 3b via one or more of routes through reference points 4. 5, 6, 7, or 8, which can be wired or wireless paths between the relevant networks, or any other route supported by the network.

A plurality of UEs 1a, 1b transmit and receive control signals or data signals to/from a 3GPP access network 2b and/or a WLAN access network 3a or 3b via reference points 9, 10, 11, 12, or 13.

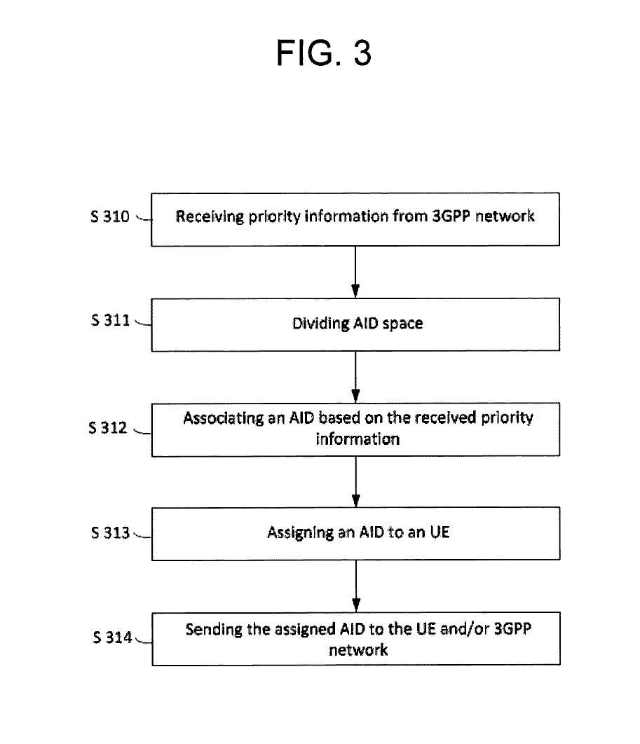

Consistent with embodiments of this disclosure, FIG. 3 shows an exemplary method for providing a unifying identifier across wireless networks such as a 3GPP network and a WLAN. At step S310, WLAN AP 3a or 3b receives priority information of a 3GPP user or users (UE 1a or 1b), such as the number of priority levels that are needed and the priority level of UE category or individual user on 3GPP network 2. This information may be passed from 3GPP network 2 to WLAN AP 3a or 3b at some suitable reference point, such as STa 4 or SWa 5 which is defined in clause 4.2,2 of 3GPP TS 23.402, as shown in FIG. 2, but the method will work irrespective of where WLAN AP 3a or 3b obtains the information on the number of priority levels and the individual priorities of the users or UEs both.

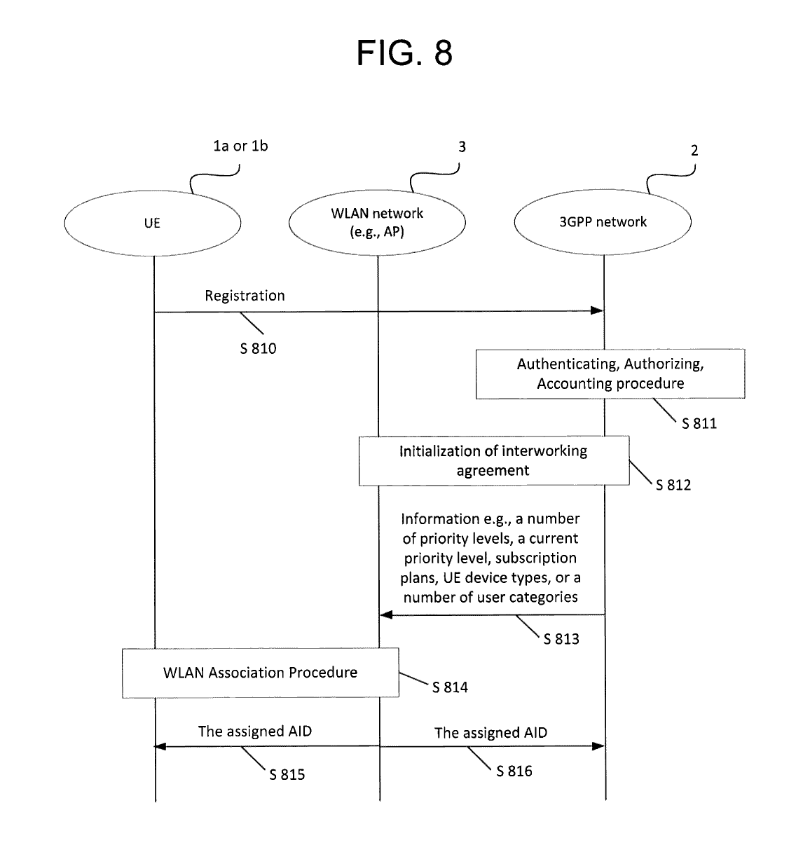

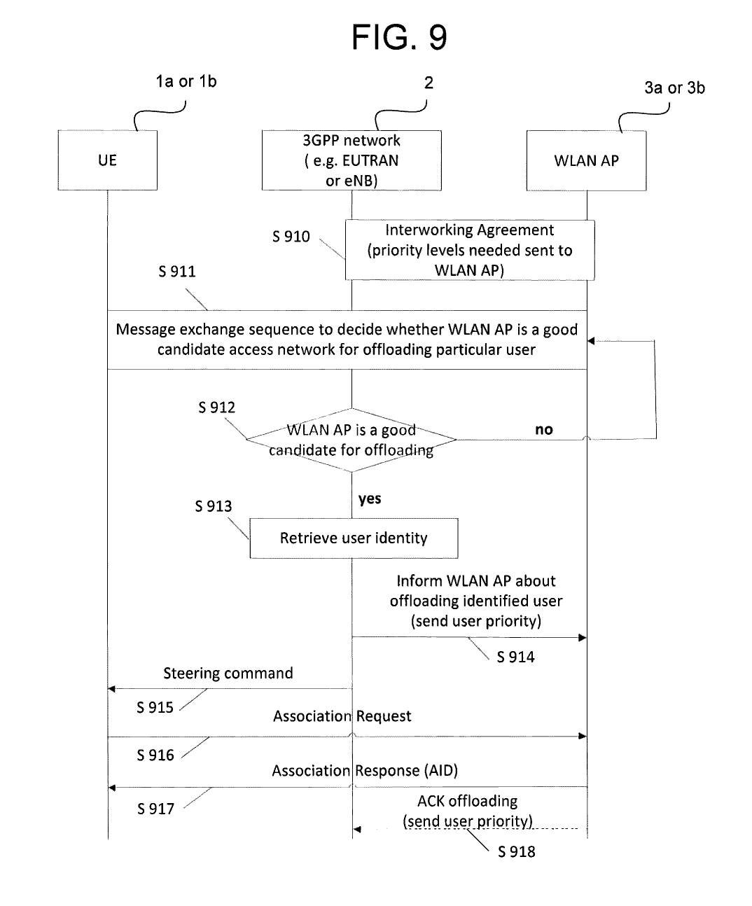

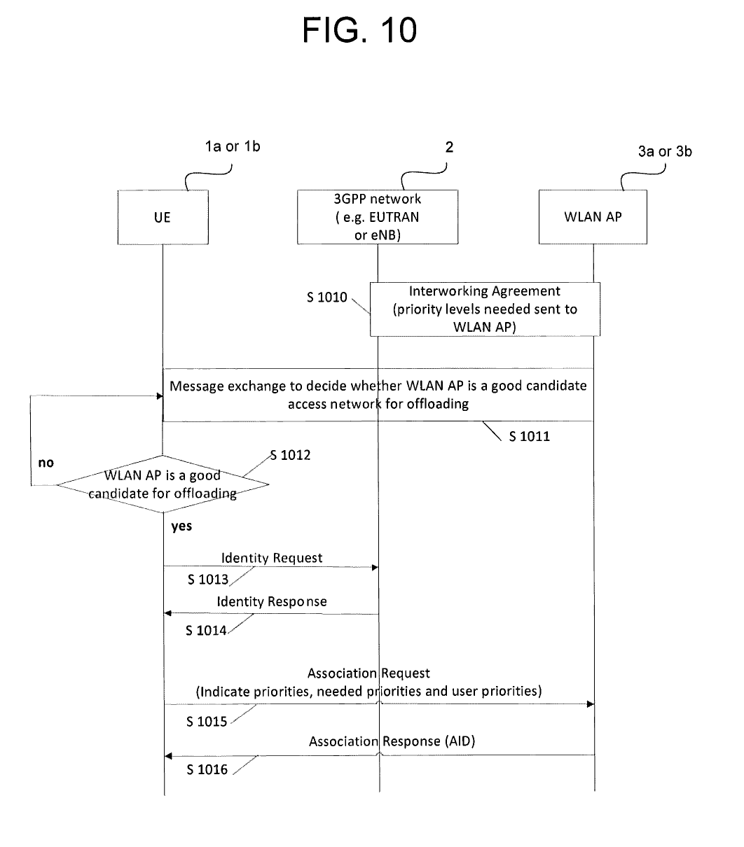

The number of priority levels can be sent once to WLAN AP 3a or 3b, upon initialization of the interworking agreement at step S812 of FIG. 8, step S910 of FIG. 9, or step S1010 of FIG. 10, and need not be sent every time the network offloads some part of the traffic of a UE. Alternatively, the number of priority levels can be indicated dynamically when needed, e.g., if the number changes over time.

Likewise, the priority information of a user or a UE 1a or 1b can be sent once to WLAN AP 3a or 3b when traffic for the user or the UE 1a or 1b is to be offloaded to WLAN network.

At step S311, WLAN AP 3a or 3b divides the AID space based on the number of priority levels and the size of the AID space. WLAN AP 3a or 3b associates an AID based on the received priority level of the UE category or individual user at step S312, assigns an AID to UE 1a or 1b at step S313, and sends the assigned AID to the UE 1a or 1b at step S314. WLAN AP 3a or 3b may also send the assigned AID to 3GPP network 2 at step S314.

In one aspect, upon association with WLAN AP 3a or 3b, UE 1a or 1b receives from WLAN AP 3a or 3b an identifier (e.g., AID) corresponding to its 3GPP user category. WLAN AP 3a or 3b assigns different identifiers to UEs in different user categorizations. In one aspect, user category may be defined based on subscription plans, QoS levels corresponding to QCI (see, e.g., QCI parameters as standardized in 3GPP TS23.203, reproduced in the table below), and/or different types of devices that may be connected in the 3GPP network 2 as different device types such as smart phones or MTC devices may have different priority levels. User category may also be based on any other parameter that affects the type, quality, and quantity of services. The particular services provided to, or otherwise how the network treats, users or user equipment or devices of a particular user category is subject to implementation. The present disclosure is not limited to any specific configuration in this respect.

| | | | | Packet | |
|---|---|---|---|---|---|
| | | | Packet | Error Loss | |
| | Resource | Priority | Delay | Rate | |
| QCI | Type | Level | Budget | (NOTE 2) | Example Services |
| 1 | GBR | 2 | 100 ms | 10⁻² | 1. Conversational Voice |
| (NOTE 3) | | | (NOTE 1, | | |
| | | | NOTE 11) | | |
| 2 | | 4 | 150 ms | 10⁻³ | 2. Conversational Video (Live |
| (NOTE 3) | | | (NOTE 1, | | Streaming) |
| | | | NOTE 11) | | |
| 3 | | 3 | 50 ms | 10⁻³ | 3. Real Time Gaming |
| (NOTE 3) | | | (NOTE 1, | | |
| | | | NOTE 11) | | |
| 4 | | 5 | 300 ms | 10⁻⁶ | 4. Non-Conversational Video |
| (NOTE 3) | | | (NOTE 1, | | (Buffered Streaming) |
| | | | NOTE 11) | | |
| 65 | | 0.7 | 75 ms | 10⁻² | 5. Mission Critical user plane Push |
| (NOTE 3, | | | (NOTE 7, | | To Talk voice (e.g., MCPTT) |
| NOTE 9) | | | NOTE 8) | | |
| 66 | | 2 | 100 ms | 10⁻² | 6. Non-Mission-Critical user plane |
| (NOTE 3) | | | (NOTE 1, | | Push To Talk voice |
| | | | NOTE 10) | | |
| 5 | Non-GBR | 1 | 100 ms | 10⁻⁶ | 7. IMS Signalling |
| (NOTE 3) | | | (NOTE 1, | | |
| | | | NOTE 10) | | |
| 6 | | 6 | 300 ms | 10⁻⁶ | 8. Video (Buffered Streaming) |
| (NOTE 4) | | | (NOTE 1, | | TCP-based (e.g., www, e-mail, chat, ftp, p2p |
| | | | NOTE 10) | | file sharing, progressive video, etc.) |
| 7 | | 7 | 100 ms | 10⁻³ | 9. Voice, |
| (NOTE 3) | | | (NOTE 1, | | Video (Live Streaming) |
| | | | NOTE 10) | | Interactive Gaming |
| 8 | | 8 | 300 ms | 10⁻⁶ | 10. |
| (NOTE 5) | | | (NOTE 1, | | Video (Buffered Streaming) |
| 9 | | 9 | NOTE 10) | | TCP-based (e.g., www. e-mail, chat, ftp. p2p |
| (NOTE 6) | | | | | file |
| | | | | | 11. sharing, progressive video, etc.) |
| 69 | | 0.5 | 60 ms | 10⁻⁶ | 12. Mission Critical delay sensitive |
| (NOTE 3, | | | (NOTE 7, | | signalling (e.g., MC-PTT signalling) |
| NOTE 9) | | | NOTE 8) | | |
| 70 | | 5.5 | 200 ms | 10⁻⁶ | 13. Mission Critical Data (e.g. example |
| (NOTE 4) | | | (NOTE 7, | | services are the same as QCI 6/8/9) |
| | | | NOTE 10) | | |

(NOTE 1): A delay of 20 ms for the delay between a PCEF and a radio base station should be subtracted from a given PDB to derive the packet delay budget that applies to the radio interface. This delay is the average between the case where the PCEF is located “close” to the radio base station (roughly 10 ms) and the case where the PCEF is located “far” from the radio base station, e.g. in case of roaming with home routed traffic (the one-way packet delay between Europe and the US west coast is roughly 50 ms). The average takes into account that roaming is a less typical scenario. It is expected that subtracting this average delay of 20 ms from a given PDB will lead to desired end-to-end performance in most typical cases. Also, note that the PDB defines an upper bound. Actual packet delays - in particular for GBR traffic - should typically be lower than the PDB specified for a QCI as long as the UE has sufficient radio channel quality.
(NOTE 2): The rate of non congestion related packet losses that may occur between a radio base station and a PCEF should be regarded to be negligible. A PELR value specified for a standardized QCI therefore applies completely to the radio interface between a UE and radio base station.
(NOTE 3): This QCI is typically associated with an operator controlled service, i.e., a service where the SDF aggregate's uplink/downlink packet filters are known at the point in time when the SDF aggregate is authorized. In case of E-UTRAN this is the point in time when a corresponding dedicated EPS bearer is established/modified.
(NOTE 4): If the network supports Multimedia Priority Services (MPS) then this QCI could be used for the prioritization of non real-time data (i.e. most typically TCP-based services/applications) of MPS subscribers.
(NOTE 5): This QCI could be used for a dedicated “premium bearer” (e.g. associated with premium content) for any subscriber/subscriber group. Also in this case, the SDF aggregate's uplink/downlink packet filters are known at the point in time when the SDF aggregate is authorized. Alternatively, this QCI could be used for the default bearer of a UE/PDN for “premium subscribers”.
(NOTE 6): This QCI is typically used for the default bearer of a UE/PDN for non privileged subscribers. Note that AMBR can be used as a “tool” to provide subscriber differentiation between subscriber groups connected to the same PDN with the same QCI on the default bearer.
(NOTE 7): For Mission Critical services, it may be assumed that the PCEF is located “close” to the radio base station (roughly 10 ms) and is not normally used in a long distance, home routed roaming situation. Hence delay of 10 ms for the delay between a PCEF and a radio base station should be subtracted from this PDB to derive the packet delay budget that applies to the radio interface.
(NOTE 8): In both RRC Idle and RRC Connected mode, the PDB requirement for these QCIs can be relaxed (but not to a value greater than 320 ms) for the first packet(s) in a downlink data or signalling burst in order to permit reasonable battery saving (DRX) techniques.
(NOTE 9): It is expected that QCI-65 and QCI-69 are used together to provide Mission Critical Push to Talk service (e.g., QCI-5 is not used for signalling for the bearer that utilizes QCI-65 as user plane bearer). It is expected that the amount of traffic per UE will be similar or less compared to the IMS signalling.
(NOTE 10): In both RRC Idle and RRC Connected mode, the PDB requirement for these QCIs can be relaxed for the first packet(s) in a downlink data or signalling burst in order to permit battery saving (DRX) techniques.
(NOTE 11): In RRC Idle mode, the PDB requirement for these QCIs can be relaxed for the first packet(s) in a downlink data or signalling burst in order to permit battery saving (DRX) techniques.

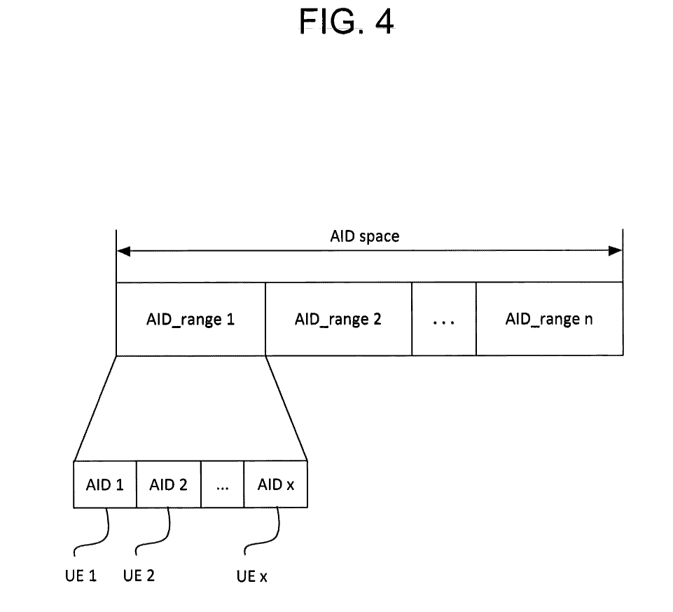

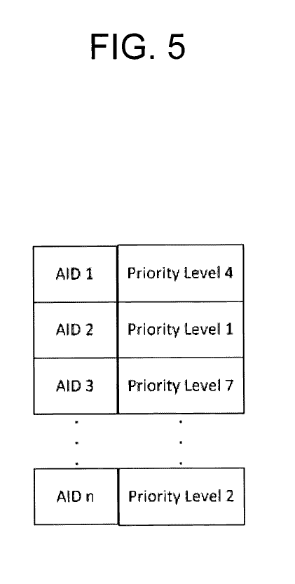

FIG. 4 illustrates an exemplary embodiment of dividing AID space (step S311 of FIG. 3). As shown in FIG. 4, the AID space may be divided into n ranges, where n is a number associated with user categories needed in the 3GPP network 2. For example, AID range 1, AID range 2, . . . , AID_range n may be arranged in ascending order of relative priority, meaning that. AID₁₃ range i has lower priority than AID_range j when i<j. Higher priority AlDs are assigned to users with higher priority in 3GPP network 2 in terms of user category as discussed above. Lower priority AIDs are assigned to users with lower priority in 3GPP network 2. Alternatively, the AID ranges may be arranged in descending order of priority. In another aspect, the AID ranges may each be assigned predetermined priority level but may not be sequenced according to the order of priority, as shown, for example, in FIG. 5.

As shown in FIG. 4, each AID range may comprise a plurality of AlDs for a 3GPP user category, where AIDs from AID_range i indicate user category i, with i=1, 2, . . . , n. AIDs need not take consecutive values and there may be empty AID values unassigned within an AID₁₃ range. Likewise, AID ranges need not be consecutive and certain portions of the AID space might be reserved for other purposes. Further, the AID ranges need not have the same size. For example, the AID ranges with higher priorities may have fewer AIDs.

In one aspect, the whole space of AIDs may not be split into subranges. Rather, some AIDs can be assigned to STAs that associate to the WLAN merely in accordance with current 802.11 standards, and therefore are not used for interworking. There may also be unallocated AIDs reserved for new category additions. These reserved AIDs may be a block of AIDs at a particular location in the existing AID space. Alternatively, bits 15 and 16, which are currently not used (set to “1” all the time), may be used to expand the AID space, and the added AIDs can be then used for various purposes, such as new category additions.

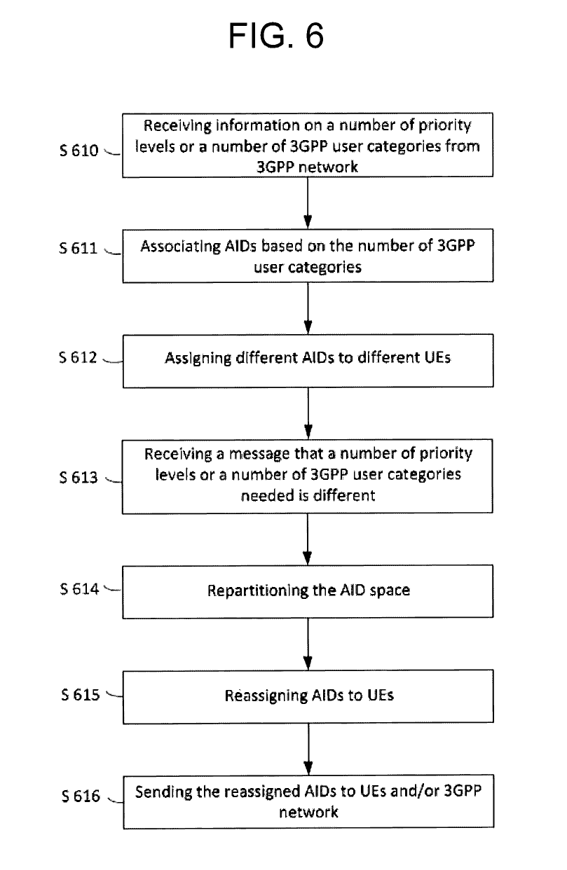

FIG. 6 shows another exemplary embodiment of a method for providing a unifying identifier in 3GPP and WLAN networks. At step S610, WLAN AP 3a or 3b receives information on a number of priority levels or a number of 3GPP user categories or priority levels from 3GPP network 2. WLAN AP 3a or 3b divides the AID space or allocates AID ranges based on the 3GPP user categories at step S611, and assigns different AIDs to different UEs at step S612. When WLAN AP 3a or 3b receives a message from 3GPP network 2 that a number of priority levels or a number of user categories needed is different at step S613, WLAN AP 3a or 3b may repartition the AID space at step S614. After repartitioning, WLAN AP 3a or 3b reassigns AIDs to UEs at step S615 and sends the reassigned AIDs to the UEs at step S616.

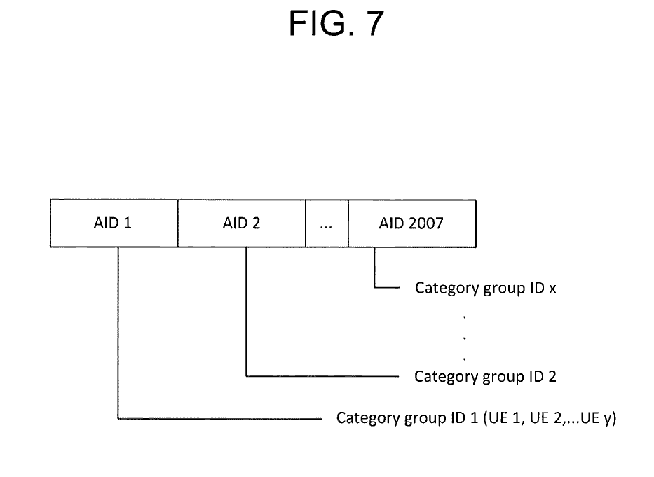

As mentioned above, WLAN AP 3a or 3b may assign UE 1a or 1b an identifier that is associated with and unique to the corresponding user category as shown in FIG. 7. Consequently, both the 3GPP network 2 and WLAN network use a unique number to identify all UEs belonging to the same category so that a commensurate level of services can be provided to the same category of UEs during offloading. This is feasible because UEs in the same category likely have common properties. For example, categories may be tied to subscription plans or other parameters indicating QoS or device types. Thus, in effect, the AID becomes a category group identifier. Such a category group identifier can be used to deliver common information, e.g., information of multicast or broadcast transmission from WLAN AP 3a or 3b to a group of stations sharing common characteristics (e.g., common device type, common QoS level, etc.).

Because AIDs in WLAN networks generally identify individual users or user devices, a specific range of AIDs may be used to identify a category or a set of users. This range may be outside the 2007 AID values that are currently used and indicated by other means, e.g., the 2 reserved bits 15 and 16.

As in FIG. 7, there are AID spaces 1-2007, WLAN AP 3a or 3b may assign AIDs based on user categories, mapping AIDs to group identifiers in accordance with a vector of AID 1, . . . , AID x. x may be equal to or less than 2007. This means that WLAN AP 3a or 3b may assign all 2007 of AIDs to user categories, or assign some, but not all, of the 2007 AIDs, to user categories when the number of user categories is less than 2007. WLAN AP 3a or 3b may assign the same AID to a plurality of UEs that correspond to the same category. For example, AID 1 may be assigned to a plurality of UEs with a category #1 in 3GPP network 2.

By appropriate assignment of AIDs, WLAN AP 3a or 3b can control the information also sent to and from different users. For example, WLAN AP 3a or 3b may indicate that it has downlink data for the user by setting the bit corresponding to the user's AID by indicating the AID on a TIM (Traffic Indication Map). If an AID indicates a group of UEs, as discussed above, WLAN AP 3a or 3b can indicate the presence of multicast/broadcast traffic by setting the bit in the TIM that corresponds to the AID.

With AIDs according to device type, QoS indication, etc., WLAN AP 3a or 3b can send in the downlink common information in a TIM transmission. Alternatively, a common group/category identifier as discussed above can be used to transmit such common information through a single transmission. In one aspect, the set of common group identifiers can be used along with AID 0 to indicate broadcast/multicast traffic.

FIG. 8 illustrates an exemplary embodiment of providing a unifying identifier in 3GPP and WLAN networks. When UE 1a or 1b registers with 3GPP network 2 at step S810, 3GPP network 2 performs authenticating, authorizing, and accounting procedure at step S811. At S812, initialization of interworking agreement is performed between 3GPP network 2 and WLAN network 3a or 3b. This initialization step can be performed before step S810 or step S811. At S813, 3GPP network 2 sends WLAN AP 3a or 3b information relevant for UE 1 a or 1b, for example, the number of needed priority levels, a current priority level of UE 1a or 1b, subscription plans, device types, or the number of user categories. At step S814, WLAN AP 3a or 3b and UE 1a or 1b perform WLAN association procedure based on the received information and WLAN AP 3a or 3 assigns an AID to UE 1a or 1b. Then, WLAN AP 3a or 3b sends the assigned AID to UE 1a or 1b at step S815, and optionally to 3GPP network 2 at step S816.

FIG. 9 illustrates an exemplary embodiment of providing a unifying identifier based on a network-centric mode with traffic offload decision where the 3GPP network decides whether WLAN network is an appropriate access network to offload IP traffic. At step S910, interworking agreement procedure is performed between 3GPP network 2 (e.g., EUTRAN or eNB, evolved Node B) and WLAN AP 3a or 3b. During interworking agreement procedure, 3GPP network 2 may send priority levels to WLAN AP 3a or 3b. At step S911, UE 1a or 1b and WLAN AP 3a or 3b exchange messages regarding whether WLAN AP 3a or 3b is a good candidate access network for offloading IP traffic. At step S912, 3GPP network 2 decides whether WLAN AP 3a or 3b is a good candidate for offloading. If WLAN AP 3a or 3b is determined to be a good candidate, 3GPP network 2 retrieves user identity information within the 3GPP network 2 at step S913. If WLAN AP 3a or 3b is determined not to be a good candidate, 3GPP network 2 repeats step S911 to search for another candidate WLAN AP. Once 3GPP network 2 retrieves user identity at step S913, 3GPP network 2 informs WLAN AP 3a or 3b about offloading the identified user at step S914. At step S914, 3GPP network 2 may send user priority information to WLAN AP 3a or 3b. Then, 3GPP network 2 sends a steering command to indicate to UE 1a or 1b that it should move its traffic to WLAN AP 3a or 3b that has been decided. In the steering command, the 3GPP network 2 may also include different identifiers for the WLAN AP 3a or 3b, such as SSID (Service Set IDentifier), HESSID (Homogenous extended SSID), BSSID (Basic SSID), or other parameters that will be needed for steering traffic to a particular network access. Then, UE 1a or 1b sends an Association Request message to WLAN AP 3a or 3b at step S916, and WLAN AP 3a or 3b sends an Association Response message with an assigned AID to UE 1a or 1b at step S917. Optionally, at step S918, WLAN AP 3a or 3b sends an ACK (acknowledgement) message to 3GPP network 2 to notify successful completion of traffic-offloading procedure with the particular user priority.

In one aspect, to avoid collision and confusion caused by substantially simultaneous requests from multiple terminals, the Association Request message at step S916 may include the current user priority information so that WLAN AP 3a or 3b may match it with the information received at step S914. This would require a new type of Association Request message that can be used, for example, during 3GPP-WLAN interworking. Also, inclusion of the user priority information is optional if WLAN AP 3a or 3b does not accept new association requests from offloading users, unless it has acknowledged a successful offloading of the last user.

FIG. 10 illustrates an exemplary embodiment of providing a unifying identifier based on a UE-centric mode, where UE 1a or 1b decides whether WLAN network is a good access network technology to offload IP traffic. At step S1010, interworking agreement procedure is performed between 3GPP network 2 (e.g., EUTRAN or eNB) and WLAN AP 3a or 3b. At step S1011, UE 1a or 1b and WLAN AP 3a or 3b exchange messages regarding whether WLAN AP 3a or 3b is a good candidate access network for offloading. WLAN AP 3a or 3b may send UE 1a or 1b a list of candidate access points in WLAN network. UP 1a or 1b may send WLAN AP 3a or 3b information to be used to decide that an access point of the second network is a good candidate for IP traffic offloading, such information as a list of candidate access points, power levels of each of candidate access points, service set of identifiers (SSIDs) of each of candidate access points, or an indication of a user preferred access point. At step S1012, UE 1a or 1b decides whether WLAN AP 3a or 3b is a good candidate. If WLAN AP 3a or 3b is determined to be a good candidate, UE 1a or 1b sends an Identity Request message to 3GPP network 2 at step S1013, and receives an Identity Response message in response to the Identity Request message from 3GPP network 2 at step S1014. Identity information in an Identity Request message or Identity Response message may be any information related to the UE 1a or 1b such as the UE's subscription plan, device type, or some other priority it may have in 3GPP network 2, etc. If WLAN AP 3a or 3b is determined not to be a good candidate, UE 1a or 1b repeats step S1011 to search for another good candidate WLAN AP. Once UE 1a or 1b retrieves user identity information at step S1014, UE 1a or 1b sends an Association Request message to WLAN AP 3a or 3b at step S1015, WLAN AP 3a or 3b sends the UE 1a or 1b an Association Response message with an assigned AID at step S1016. Optionally, WLAN AP 3a or 3b may send the assigned AID to 3GPP network 2 as well. WLAN AP 3a or 3b may send an ACK message to 3GPP network 2 to notify successful completion of traffic-offloading procedure.

The UE-centric mode may require a change in an Association Request message at step S1015, such that the Association Request message includes such information as needed priorities and user priorities. Alternatively, needed priorities (i.e., possible priorities of UEs on 3GPP network 2) may not be required for an Association Request message but may be sent as part of the interworking agreement between 3GPP network 2 and WLAN AP 3a or 3b.

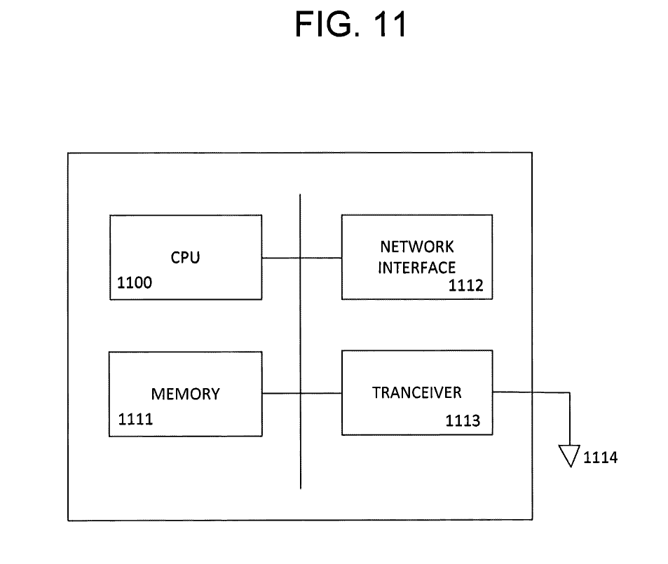

FIG. 11 illustrates an exemplary block diagram of an apparatus, e.g., a network apparatus such as WLAN AP 3a or 3b or 3GPP network 2 apparatus, or a user equipment apparatus such as a UE 1a or 1b. Network apparatus comprises one or more processors 1110, memory 1111, a network interface 1112, and a transceiver 1113. The transceiver 1113 may be coupled to one or more antennas 1114.

The one or more processors 1110 may comprise a CPU (central processing unit) and may include a single core or multiple core processor system with parallel processing capability. The one or more processors 1110 may use logical processors to simultaneously execute and control multiple processes. One of ordinary skill in the art would understand that other types of processor arrangements could be implemented that provide for the capabilities disclosed herein.

The one or more processors 1110 execute some or all of the functionalities described above for either the UE or the wireless networks (e.g., 3GPP or WLAN). Alternative embodiments of the network apparatus may include additional components responsible for providing additional functionality, including any of the functionality identified above and/or any functionality necessary to support the embodiments described above.

The memory 1111 may include one or more storage devices configured to store information used by the one or more processor 1110 to perform certain functions according to exemplary embodiments. Memory 1111 may include, for example, a hard drive, a flash drive, an optical drive, a random-access memory (RAM), a read-only memory (ROM), or any other computer-readable medium known in the art. Memory 1111 can store instructions to be executed by the one or more processor 1110. Memory 1111 may be volatile or non-volatile, magnetic, semiconductor, optical, removable, non-removable, or other type of storage device or tangible computer-readable medium.

Network interface 1112 may comprise wired links, such as an Ethernet cable or the like, and/or wireless links to access nodes or different networks. Network interface 1112 allows the one or more processor 1110 to communicate with remote units via the networks.

Transceiver 1113 is used to transmit signals to a radio channel, and receives signals transmitted through the radio channel via antenna 1114.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method of providing a unifying identifier for a user device across different wireless networks including a first wireless network and a second wireless network, the method comprising:
receiving, at the second wireless network, information from the first wireless network;
associating a unifying identifier for the user device based on the received information; and
assigning the unifying identifier to the user device,
wherein the information from the first wireless network indicates a priority or a quality or level of service provided to the user device by the first wireless network.

2. The method of claim 1, further comprising communicating with the user device using the unifying identifier.

3. The method of claim 2, wherein the second wireless network communicates with the user device for part of the user device's traffic.

4. The method of claim 1, wherein the first wireless network and the second wireless network employ different access technologies.

5. The method of claim 1, wherein the information received from the first wireless network comprises priority information, the priority information including a number of priority levels or a current priority level for the user device.

6. The method of claim 1, wherein the information received from the first wireless network comprises user categorization information, the user categorization information including subscription plans, device types, or a number of user categories.

7. The method of claim 1, further comprising sending the assigned unifying identifier to the first wireless network.

8. The method of claim 1, wherein the first wireless network is a cellular network such as a 3GPP network.

9. The method of claim 1, wherein the second wireless network is a wireless local area network (WLAN).

10. The method of claim 9, wherein the unifying identifier is an association identifier (AID).

11. The method of claim 10, further comprising dividing an AID space by the second wireless network.

12. The method of claim 11, wherein dividing the AID space comprises dividing at least part of the AID space into a plurality of AID ranges.

13. The method according to claim 12, wherein each of the plurality of AID ranges comprises a plurality of AIDs.

14. The method according to claim 13, wherein some of the plurality of AIDs each correspond to a priority level.

15. The method according to claim 14, wherein some of the plurality of AIDs each indicate a user device.

16. The method of claim 13, wherein at least some of the plurality of AIDs each correspond to a category of user devices.

17. The method of claim 1, wherein associating a unifying identifier further comprises associating a plurality of AIDs based on a number of user categories of the first wireless network.

18. The method of claim 1, wherein assigning the unifying identifier comprises assigning different unifying identifiers to different user devices.

19. The method of claim 1, wherein the information received from the first wireless network includes a number of priority levels, the method further comprising receiving, by the second wireless network, a message from the first wireless network indicating a different number of priority levels.

20. The method of claim 1, wherein both the first and second wireless networks communicate with the user device using the unifying identifier.

21. The method of claim 1, wherein the unifying identifier is the same for user devices belong to a same user category.

22. The method of claim 1, wherein the first wireless network and the second wireless network employ separate subscription plans.

23. A method of a user device communicating with a first wireless network and a second wireless network, the method comprising:
while in communication with the first wireless network, receiving a unifying identifier from the second wireless network, wherein the unifying identifier reflects a priority or a quality or level of service provided to the user device by the first wireless network; and
communicating with the second wireless network using the unifying identifier.

24. The method of claim 23, further comprising, prior to receiving the unifying identifier from the second wireless network:
receiving an indication from the first wireless network to offload traffic to the second wireless network; and
sending a request to associate with the second wireless network.

25. The method of claim 23, further deciding an access point of the second network as a good candidate for offloading traffic from the first wireless network to the second wireless network.

26. The method of claim 23, wherein the first wireless network and the second wireless network employ different access technologies.

27. The method of claim 23, wherein the first wireless network and the second wireless network employ separate subscription plans.

28. The method of claim 23, wherein the first wireless network is a cellular network such as a 3GPP network.

29. The method of claim 23, wherein the second wireless network is a wireless local area network (WLAN).

30. The method of claim 29, wherein the unifying identifier is an association identifier (AID).

31. The method of claim 23, wherein the unifying identifier identifies the user device.

32. The method of claim 23, wherein the unifying identifier identifies a category that the user device belongs to.

33. A method of a first wireless network for offloading at least part of a user device's traffic to a second wireless network, the method comprising:
transmitting information to the second wireless network, wherein the information indicates a priority or a quality or level of service provided to the user device by the first wireless network;
indicating to the user device to offload traffic to the second wireless network; and
receiving from the second wireless network a unifying identifier for the user device, the unifying identifier associated with the priority or quality or level of service.

34. The method of claim 33, wherein the first wireless network and the second wireless network employ different access technologies.

35. The method of claim 33, wherein the information comprises priority information, the priority information including a number of priority levels or a current priority level for the user device.

36. The method of claim 33, wherein the information comprises user categorization information, the user categorization information including subscription plans, device types, or a number of user categories.

37. The method of claim 33, wherein the first wireless network is a cellular network such as a 3GPP network.

38. The method of claim 33, wherein the second wireless network is a wireless local area network (WLAN).

39. The method of claim 33, further transmitting a message indicating a different number of priority levels.

40. The method of claim 33, further comprising identifying an access point of the second network as a good candidate for traffic offloading, wherein transmitting information to the second wireless network comprises transmitting the information to the identified access point.

41. The method of claim 33, wherein both the first and second wireless networks communicate with the user device using the unifying identifier.

42. The method of claim 33, wherein the second wireless network is a wireless local area network and the unifying identifier is an association identifier (AID).

43. The method according to claim 42, wherein the AID corresponds to a priority level.

44. The method of claim 33, wherein the unifying identifier identifies the user device.

45. The method of claim 33, wherein the unifying identifier identifies a category that the user device belongs to.

46. A device for communicating with a first wireless network and a second wireless network, the device comprising:
a processor; and
a computer readable storage medium storing programming for execution by the processor,
wherein the processor is configured for the device to:
while in communication with the first wireless network, receive a unifying identifier from the second wireless network, wherein the unifying identifier reflects a priority or a quality or level of service provided to the user device by the first wireless network; and
communicate with the second wireless network with using the unifying identifier.

47. The device of claim 46, wherein the processor is further configured such that the device
prior to receiving the unifying identifier from the second wireless network, receives an indication from the first wireless network to offload traffic to the second wireless network; and
sends a request to associate with the second wireless network.

48. The device of claim 46, the processor further configured to decide an access point of the second network as a good candidate for offloading traffic from the first wireless network to the second wireless network.

49. The device of claim 46, wherein the first wireless network and the second wireless network employ different access technologies.

50. The device of claim 46, wherein the first wireless network and the second wireless network employ separate subscription plans.

51. The device of claim 46, wherein the first wireless network is a cellular network such as a 3GPP network.

52. The device of claim 46, wherein the second wireless network is a wireless local area network (WLAN).

53. The device of claim 52, wherein the unifying identifier is an association identifier (AID).

54. The device of claim 46, wherein the unifying identifier identifies the device.

55. The device of claim 46, wherein the unifying identifier identifies a category that the device belongs to.
